(19) United States
(12) Patent Application Publication
(10) Pub. No.: US 2007/0245076 A1
(43) Pub. Date: Oct. 18, 2007

(54) VOLATILE STORAGE DEVICE AND SERIAL MIXED STORAGE SYSTEM HAVING THE SAME

(75) Inventors: An-Sheng Chang, Taipei Hsien (TW); Wen-Chi Hung, Taipei Hsien (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: GIGA-BYTE TECHNOLOGY CO., LTD., Taipei Hsien (TW)

(21) Appl. No.: 11/461,996

(22) Filed: Aug. 2, 2006

(30) Foreign Application Priority Data
Apr. 12, 2006 (TW) 095113063

(51) Int. Cl. G06F 12/00

(52) U.S. Cl. 711/112

(57) ABSTRACT

A volatile storage device and a serial mixed storage system having the same are provided. The system includes an access controller, a data transmission interface, a volatile storage module, a power supply module, an expansion interface and a non-volatile storage module. The volatile storage module and non-volatile storage module are connected in series via the expansion interface. The volatile storage module and the non-volatile storage module can be used to store data under the control of the access controller. Further, the power supply module can supply the stored electric power to the access controller, volatile storage module, and non-volatile storage module, so as to keep data stored in the volatile storage module or transfer the data to the non-volatile storage module, thereby avoiding data loss caused by power cutoff.

### CROSS-REFERENCE TO RELATED APPLICATIONS

This non-provisional application claims priority under 35 U.S.C. § 119(a) on Patent Application No(s). 095113063 filed in Taiwan, R.O.C. on Apr. 12, 2006, the entire contents of which are hereby incorporated by reference.

### BACKGROUND OF THE INVENTION

1. Field of Invention

The present invention relates to a data storage device adaptable to a computer device, and more particularly to a volatile storage device and a serial mixed storage system having the same.

2. Related Art

With the progress of science and technology, workings such as calculating, recording, communicating, and query can be carried out with the help of computer devices. Therefore, computer devices have gradually become an essential tool in work and daily life. Typically, a computer device includes various storage devices, for example, random access memory (RAM), hard disk, floppy drive, or flash disk. The RAM is a volatile storage device and can provide a fast data access. On the other hand, the hard disk and floppy drive are non-volatile storage device, and provide a relative slow data access.

However, in recent years, a RAM disk is developed and used to reduce the data access time, thereby improving the overall efficiency. As such, a software design is adopted to enable the computer device to utilize a memory in the same way of using a hard disk. For example, a memory in the computer device is divided into a system block and a memory disk block, wherein the system block is provided for an operating system (OS), and the memory disk block is used to temporarily function as a hard disk. The range of the memory location and capacity of the memory disk block in the memory are declared to the OS in a start-up procedure. Then, the OS resides a management program in the system block, in which the management program is used to manage the data access of the memory disk block. When the CPU intends to access the hard disk, the management program intercepts the interrupt vector corresponding to the hard disk access and then temporarily records the data pre-determined to be stored in the hard disk into the memory disk block of the memory.

However, as the memory belongs to a volatile storage device, when the computer device is shut down, the data stored in the memory may be lost due to the cut off of the power supply. Therefore, a computer device must be provided with a hard disk, such that before the computer device is shut down, the user data registered in the memory disk block is transferred to the hard disk to avoid data loss. But, when the power supply is unexpectedly cut off, the user data registered in the memory disk block cannot be transferred to the hard disk in time, and thus the user data may still be lost due to the cut off of the electric power.

Moreover, as the memory disk block and system block share a memory space, when the computer device asks for a large memory space to execute application programs, only a small memory disk block can be used to register data.

### SUMMARY OF THE INVENTION

It is an object of the present invention to provide a volatile storage device and a serial mixed storage system having the same for solving the problems of insufficient storage capacity of the volatile storage device and data loss due to the cut off of the electric power in the conventional art and raising the speed of the computer.

Therefore, in order to achieve the above objects, a serial mixed storage system described in the present invention comprises a first storage device and a second storage device. The first storage device is a volatile storage device, which at least has an access controller, a data transmission interface, a volatile storage module, a power supply module, and an expansion interface. The data transmission interface, access controller, and volatile storage module are connected in sequence. The power supply module is connected to the volatile storage module and the access controller, wherein an electric power is stored to be supplied to the volatile storage module and access controller when the electric power is cut off, so as to maintain operations and transferring the data of the volatile storage module, thereby avoiding the possible loss of stored data caused by the cut off of the electric power.

Moreover, the access controller is connected in series with the second storage device via the expansion interface, so as to combine the capacities of the first storage device and the second storage device, thereby expanding the storage space.

Further, the access controller is used to determine the data access of the volatile storage module and the second storage device. As such, the volatile storage module and the second storage device are utilized to store data of the computer device under the control of the access controller, thereby significantly raising the overall speed of the computer device.

Moreover, the first storage device further has a power supply input interface connected to an external power supply, so as to provide electric power to the serial mixed storage system for charging and/or operating. Moreover, the first storage device can directly supply electric power to the second storage device via the expansion interface, or the first storage device can be electrically connected to the power supply module and the second storage device via a power supply output interface, so as to provide electric power required by the second storage device to operate.

The features and practice of the preferred embodiments of the present invention will be illustrated in detail below with the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a volatile storage device and a serial mixed storage system having the same according to the present invention.

FIG. 2 is a schematic view of a volatile storage device with a plurality of expansion interfaces and a serial mixed storage system having the same.

FIG. 3 is a schematic view of the volatile storage device and the serial mixed storage system having the same connected to a computer device according to the present invention.

FIG. 4 is a schematic view of the volatile storage device and the power supply module of the serial mixed storage system having the same according to the present invention, and the connection between the present invention and an external power supply.

FIG. 5 is a schematic view of the volatile storage device and the serial mixed storage system having the same supplying electric power to a second storage device according to the present invention.

FIG. 6 is a schematic view of the volatile storage device connected to the computer device according to the present invention.

FIG. 7A is a schematic view of the volatile storage device and the serial mixed storage system having the same according to a first embodiment of the present invention.

FIG. 7B is a schematic view of the volatile storage device and the serial mixed storage system having the same according to a second embodiment of the present invention.

FIG. 8A is a schematic view of the volatile storage device and the serial mixed storage system having the same according to a third embodiment of the present invention.

FIG. 8B is a schematic view of the volatile storage device and the serial mixed storage system having the same according to a fourth embodiment of the present invention.

FIG. 9A is a schematic view of the volatile storage device and the serial mixed storage system having the same according to a fifth embodiment of the present invention.

FIG. 9B is a schematic view of the volatile storage device and the serial mixed storage system having the same according to a sixth embodiment of the present invention.

### DETAILED DESCRIPTION OF THE INVENTION

The content of the present invention will be described in details in the following embodiments with accompanying drawings. The symbols mentioned in the specification are symbols in the drawings.

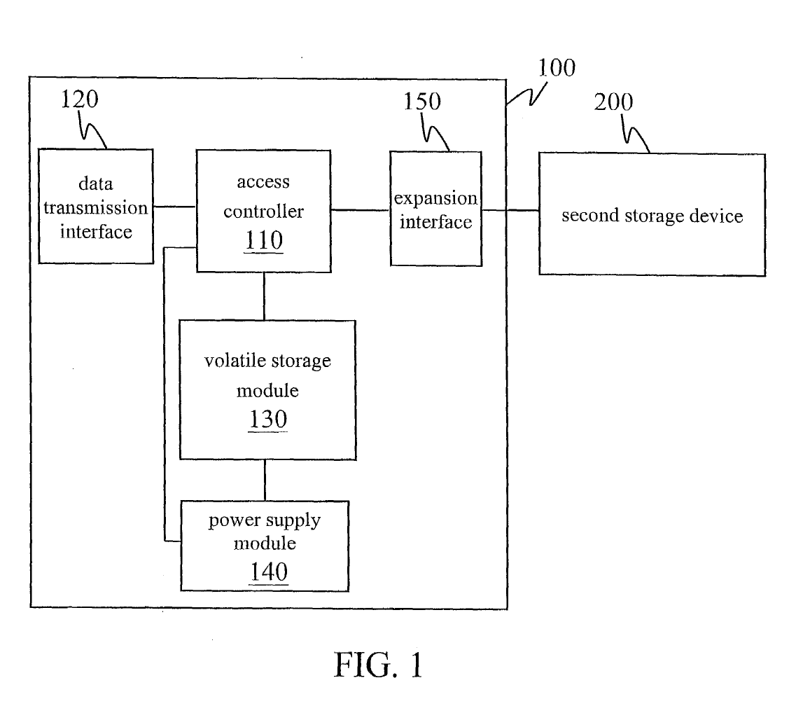

As shown in FIG. 1, it is a serial mixed storage system according to an embodiment of the present invention. The serial mixed storage system comprises a first storage device 100 and a second storage device 200.

The first storage device 100 has an access controller 110, a data transmission interface 120, a volatile storage module 130, a power supply module 140 and an expansion interface 150. The volatile storage module 130 is connected to the data transmission interface 120 through the access controller 110. The volatile storage module 130 can be volatile memories such as synchronous dynamic random access memory (SDRAM) or double data rate random access memory (DDRAM).

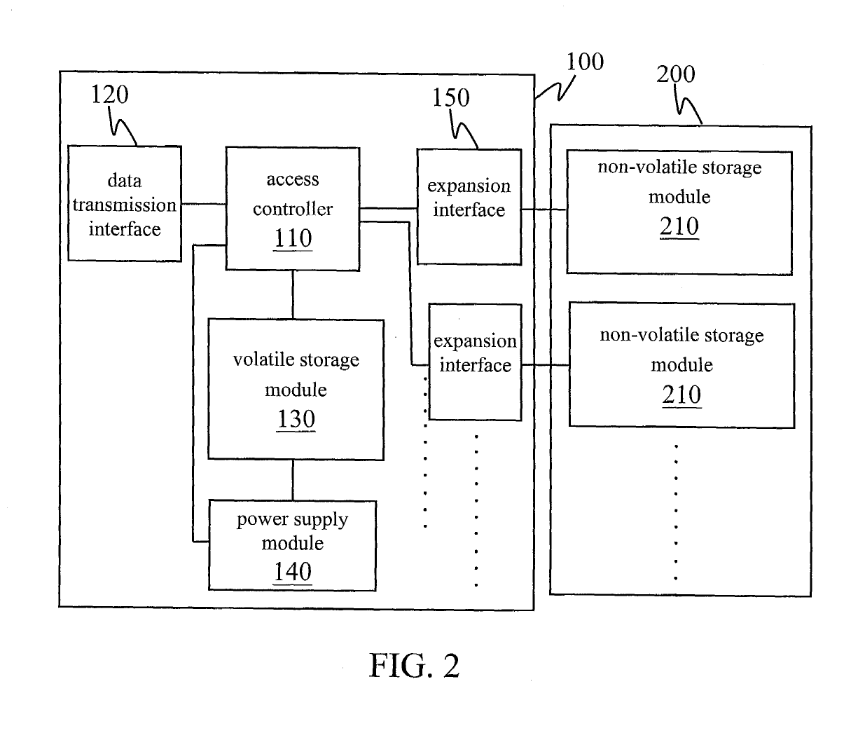

The expansion interface 150 is connected to the access controller 110 to provide connection to the second storage device 200. The expansion interface 150 can be transmission interfaces such as integrated drive electronics (IDE), serial advanced technology attachment (SATA), universal serial bus (USB), or Institute of Electrical and Electronics Engineer 1394 (IEEE 1394). As shown in FIG. 2, the second storage device 200 can comprise one or more non-volatile storage modules 210, wherein the non-volatile storage module 210 can be storage devices such as hard disks, flash disks, or memory cards. More than one expansion interface 150 can be disposed on the first storage device 100 for providing connection to more than one non-volatile storage module 210. As such, the storage space is expanded through connecting the first storage device 100 and the second storage device 200.

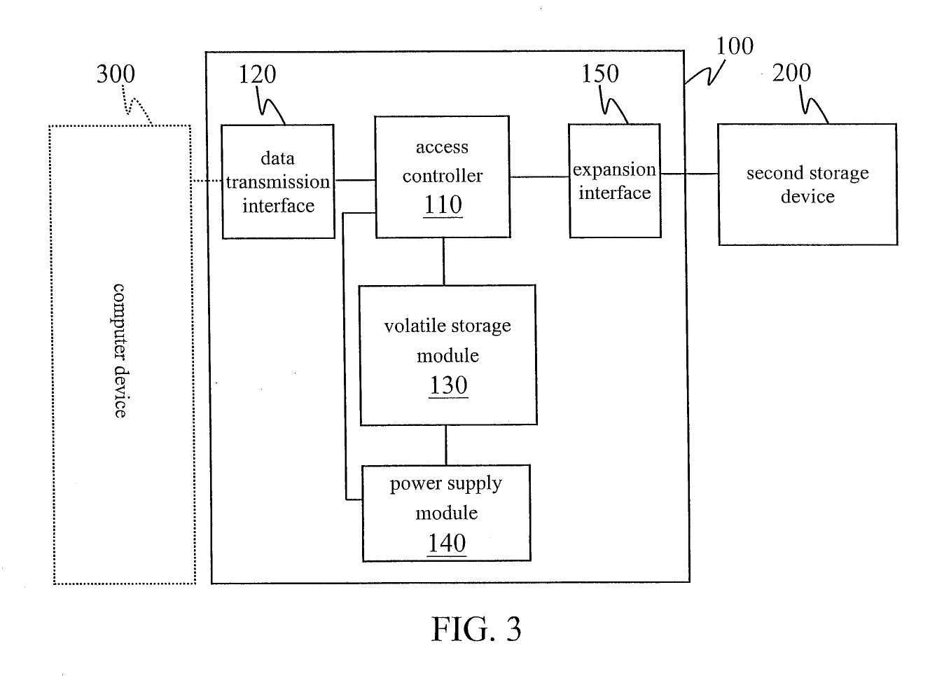

The data transmission interface 120 is used to provide connection to application devices. As shown in FIG. 3, when the serial mixed storage system of the present invention is applied to a computer device 300, the serial mixed storage system can be connected to the computer device 300 via the data transmission interface 120. The data transmission interface 120 can be transmission interfaces such as IDE, SATA, USB, or IEEE 1394.

The access controller 110 determines the data access of the volatile storage module 130 and non-volatile storage module 210. In other words, the access controller 110 receives a data access signal sent by the application device and accordingly determines accessing the volatile storage module 130 or the non-volatile storage module 210. When the computer device 300 intends to access data, the access controller 110 first stores the data preferably to the volatile storage module 130, such that the computer device 300 can quickly read the data during the next reading. When the stored data is too large for the volatile storage module 130 to store, the access controller 110 utilizes the non-volatile storage module 210 to continue the data storage.

For example, when the capacity of the volatile storage module 130 in the first storage device 100 is 8G and the capacity of the non-volatile storage module 210 in the second storage device 200 is 100G, the computer device 300 determines the serial mixed storage system to be a 108G storage device via the access controller 110 in the first storage device 100. Further, when installing an OS, the access controller 110 first preferably uses the 8G volatile storage module 130 to store data, and then uses the 100G non-volatile storage module 210 to store data. As the access speed of the volatile memory is higher than that of the non-volatile memory, the access speed is far beyond the computer device using a non-volatile memory when accessing data, thus providing a quicker speed in starting up and executing program. Moreover, when data is stored in both the volatile storage module 130 and the non-volatile storage module 210, with the disk reconfiguration program, the commonly used data in the second storage device 200 is displaced to the memory space in the volatile storage module 130, so as to greatly enhance the execution efficiency of the computer device 300.

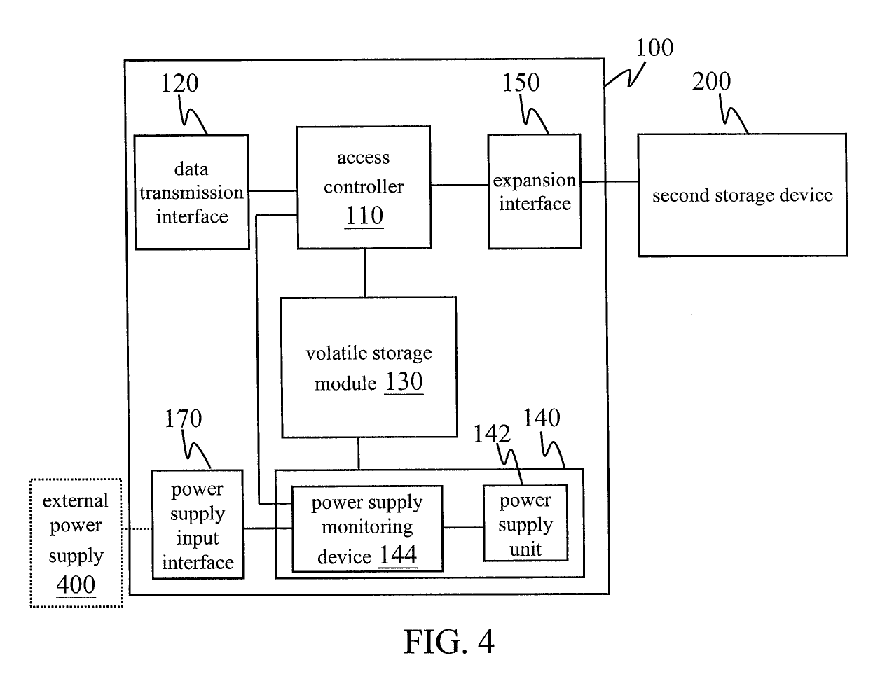

As shown in FIG. 4, the first storage device 100 further comprises a power supply input interface 170 for providing connection to an external power supply 400, so as to supply electric power to the serial mixed storage system for charging and operating. The external power supply 400 can be electric power provided by a mains supply or an application device. However, in other preferred embodiments, electric power can be obtained via the data transmission interface 120 from the application device instead of the power supply input interface 170 connected to the external power supply 400.

The power supply module 140 is connected to the volatile storage module 130 and the access controller 110, for providing the stored electric power to maintain the data stored in the volatile storage module 130 and the operation of the access controller 110 when the electric power is cut off. When the second storage device 200 is connected to the first storage device 100, the power supply module 140 also supplies electric power to the second storage device when the electric power is cut off. The power supply module 140 comprises a power supply unit 142 and a power supply monitoring device 144. The power supply unit 142 is a secondary battery (rechargeable battery) for storing electric power and supplying electric power to the serial mixed storage system when electric power is cut off, so as to maintain the operation of the system. Further, the power supply monitoring device 144 monitors the state of the power supply, and supplies the electric power stored in the power supply unit 142 to the volatile storage module 130, the access controller 110, and the second storage device 200, such that the data stored in the volatile storage module 130 is transferred to the non-volatile storage module 210 of the second storage device 200, thereby avoiding possible data loss of the volatile storage module 130 caused by the unexpected cut off of the power supply. Moreover, when the power supply is supplied again, the access controller 110 restore the data transferred to the non-volatile storage module 210 to the volatile storage module 130, and the power supply unit 142 is charged by the electric power of the external power supply 400 under the condition that the power supply is supplied again. Moreover, the power supply monitoring device 144 can be further provided with a timing mechanism to activate timing when the electric power is cut off. When the timing is ended and the power supply is not supplied yet, the access controller 110 is actuated to transfer the data in the volatile storage module 130 to the non-volatile storage module 210.

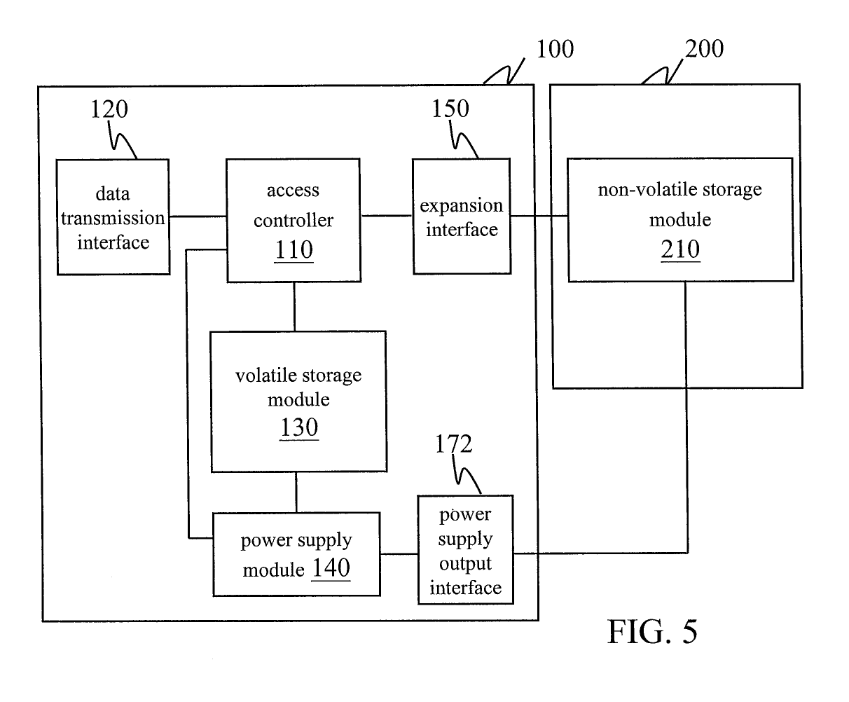

The first storage device 100 can directly supply the electric power of the power supply module 140 to the second storage device 200 via the expansion interface 150. As shown in FIG. 5, the first storage device 100 can also provide electric power required by the second storage device 200 to operate via utilizing a power supply output interface 172 to electrically connect the power supply module 140 and the second storage device 200.

In view of the above, the present invention can store the commonly used data into the volatile storage module 130, thereby raising the access speed and greatly improving the overall speed of the application device. Further, when the power supply is unexpectedly cut off, the data stored in the volatile storage module 130 can be stored by activating an automatic transfer mechanism, thus avoiding the data loss.

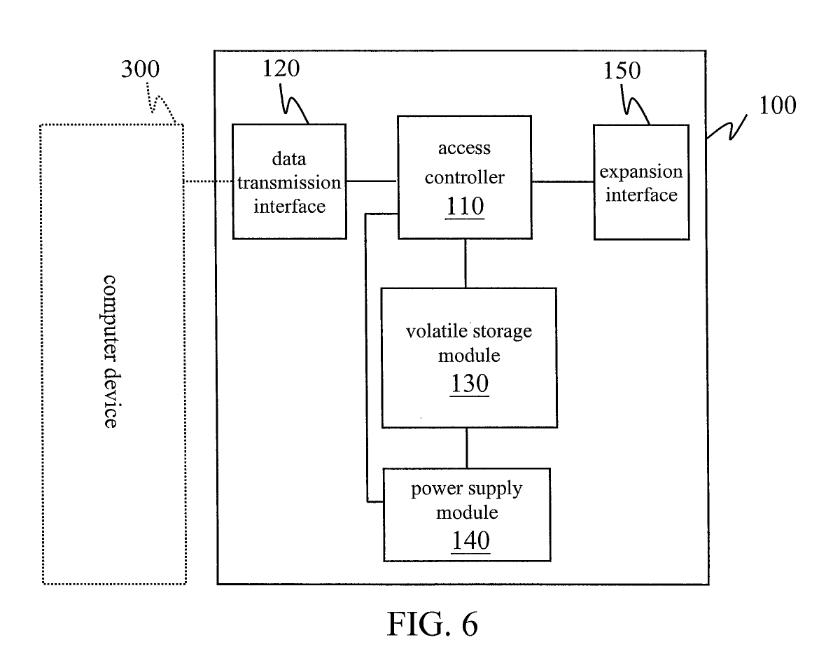

Moreover, the first storage device 100 can also be used without being connected to the second storage device. As shown in FIG. 6, only the first storage device 100 is connected to the computer device 300, and at this time, the first storage device can be used as a hard disk. When the power supply is cut off, the data in the volatile storage module 130 can be stored via the electric power provided by the power supply module 140 and be re-used after the power supply is supplied again.

The preferred embodiments of the present invention are described as follows.

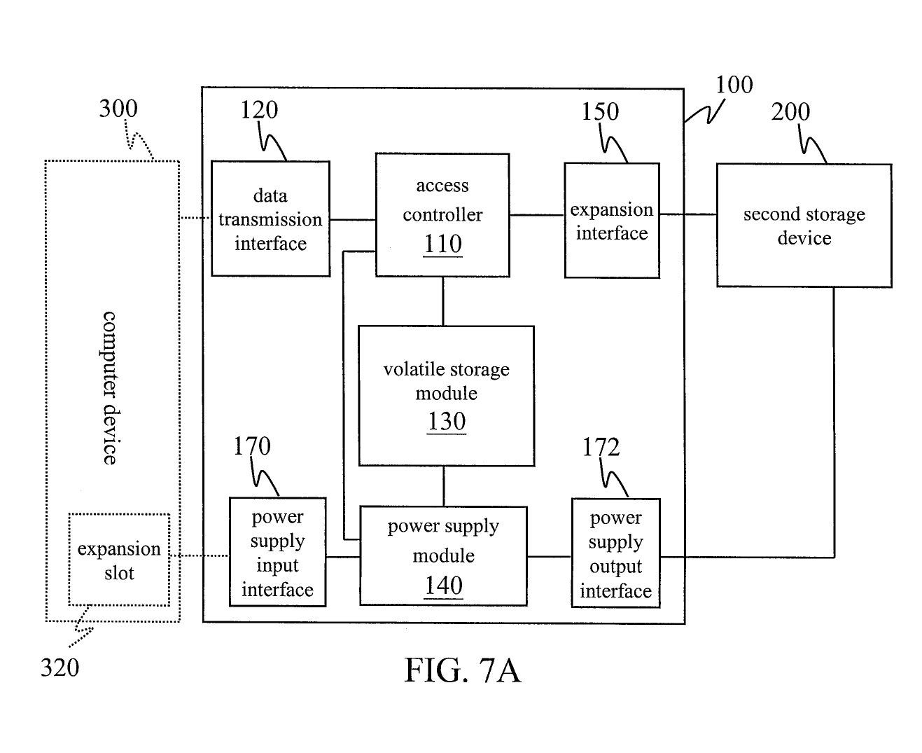

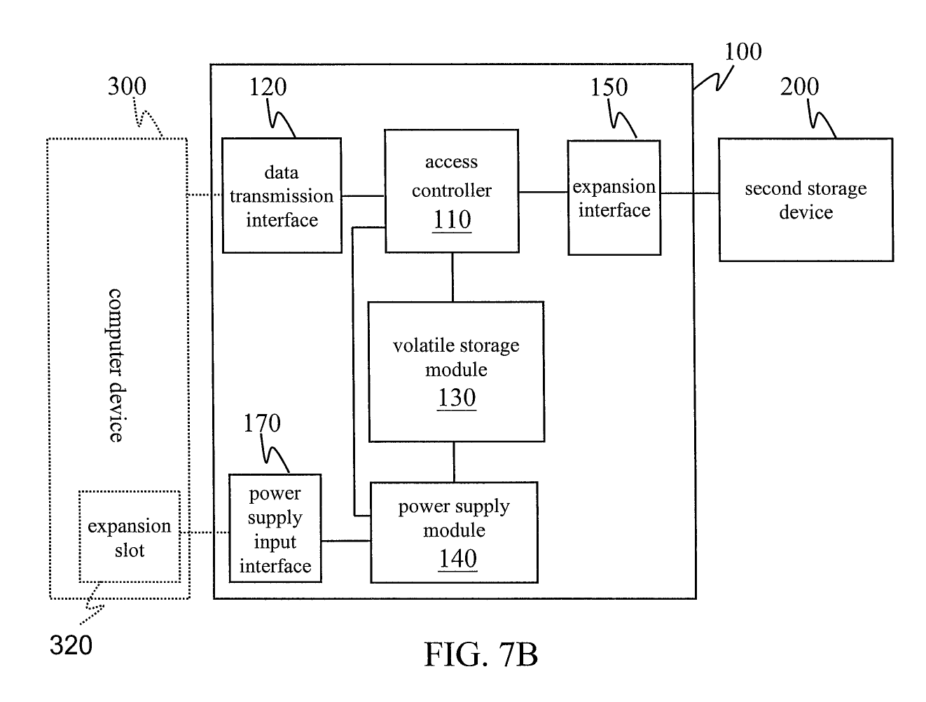

In a first embodiment as shown in FIG. 7A, the first storage device 100 is in the form of an interface card and transmits data by connecting the data transmission interface 120 to the computer device 300. The data transmission interface 120 can be transmission interfaces such as IDE or SATA. The power supply input interface 170 is connected to an expansion slot 320 of the computer device 300 and the power supply input interface 170 can be transmission interfaces such as ISA, PCI or PCI-Express. When the non-volatile storage module 210 of the second storage device 200 is a hard disk, the expansion interface 150 for providing connection to the second storage device can be transmission interfaces such as IDE or SATA. At this time, the first storage device 100 supplies the electric power of the power supply module 140 to the second storage device 200 via the power supply output interface 172. The first storage device 100 can be wired from the expansion interface 150 to a back plate (baffle) of the interface card or to the outside of the case of the computer device 300, so as to provide connection to the second storage device 200 directly from the exterior of the case.

In a second embodiment as shown in FIG. 7B, the first storage device 100 is in the form of an interface card and transmits data by connecting the data transmission interface 120 to the computer device 300, wherein the data transmission interface 120 can be transmission interfaces such as IDE or SATA. The power supply input interface 170 is connected to the expansion slot 320 of the computer device 300 and the power supply input interface 170 can be transmission interfaces such as ISA, PCI, or PCI-Express. When the non-volatile storage module 210 of the second storage device 200 is a flash disk, a card reader, or a memory card that can be directly inserted in a USB or IEEE 1394, the expansion interface 150 for providing connection to the second storage device 200 can be transmission interfaces such as USB or IEEE 1394. The first storage device 100 can be wired from the expansion interface 150 to a back plate (baffle) of the interface card or to the exterior of the case of the computer device 300, so as to provide connection to the second storage device 200 directly from the exterior of the case.

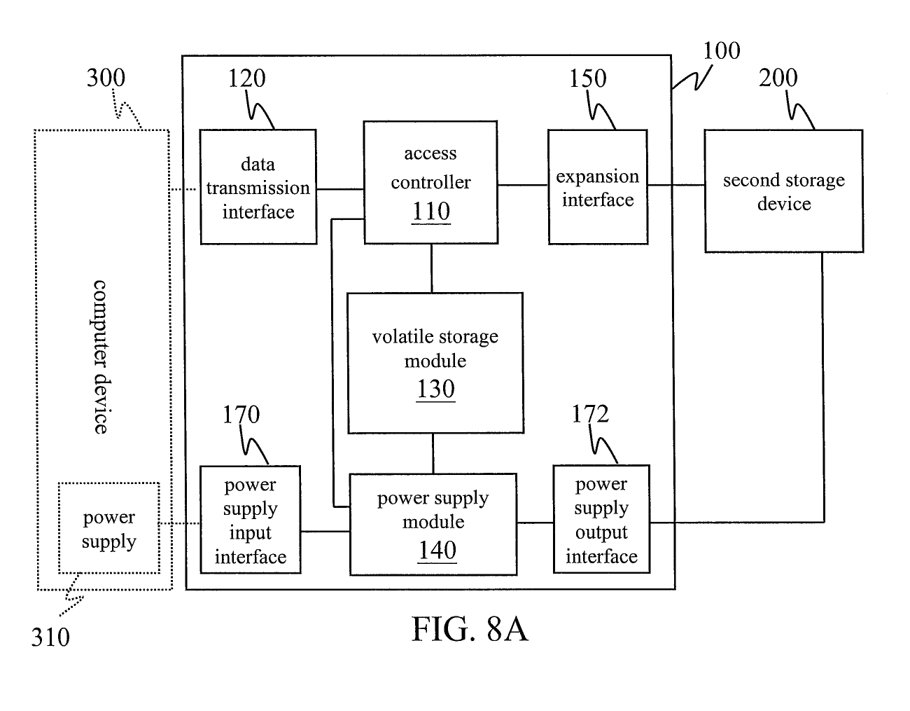

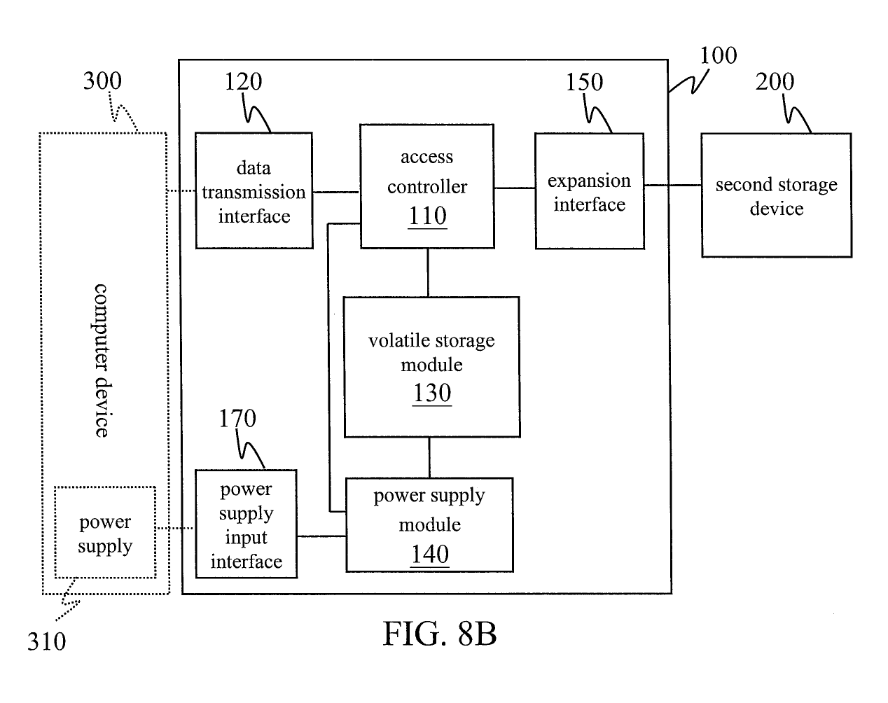

In a third embodiment as shown in FIG. 8A, the first storage device 100 can be installed in the same way of installing the hard disk drive or optical disk drive in the case in the prior art, and can transmit data by connecting the data transmission interface 120 to the computer device 300, wherein the data transmission interface 120 can be transmission interfaces such as IDE or SATA. The power supply input interface 170 is connected to a power supply 310 of the computer device 300. When the non-volatile storage module 210 of the second storage device 200 is a hard disk, the expansion interface 150 for providing connection to the second storage device 200 can be transmission interfaces such as IDE or SATA. At this time, the first storage device 100 supplies the electric power of the power supply module 140 to the second storage device 200 via the power supply output interface 172.

In a fourth embodiment as shown in FIG. 8B, the first storage device 100 can be installed in the same way of installing the hard disk drive or optical disk drive in the case in the prior art, and can transmit data by connecting the data transmission interface 120 to the computer device 300, wherein the data transmission interface 120 can be transmission interfaces such as IDE or SATA. The power supply input interface 170 is connected to the power supply 310 of the computer device 300. When the non-volatile storage module 210 of the second storage device 200 is a flash disk, a card reader, or a memory card that can be directly inserted into a USB or IEEE 1394, the expansion interface 150 for providing connection to the second storage device 200 can be transmission interfaces such as USB or IEEE 1394. The expansion interface 150 of the first storage device 100 can be directly exposed outside the computer device 300 or can be wired to the outside of the case of the computer device 300 for providing connection to the second storage device 200.

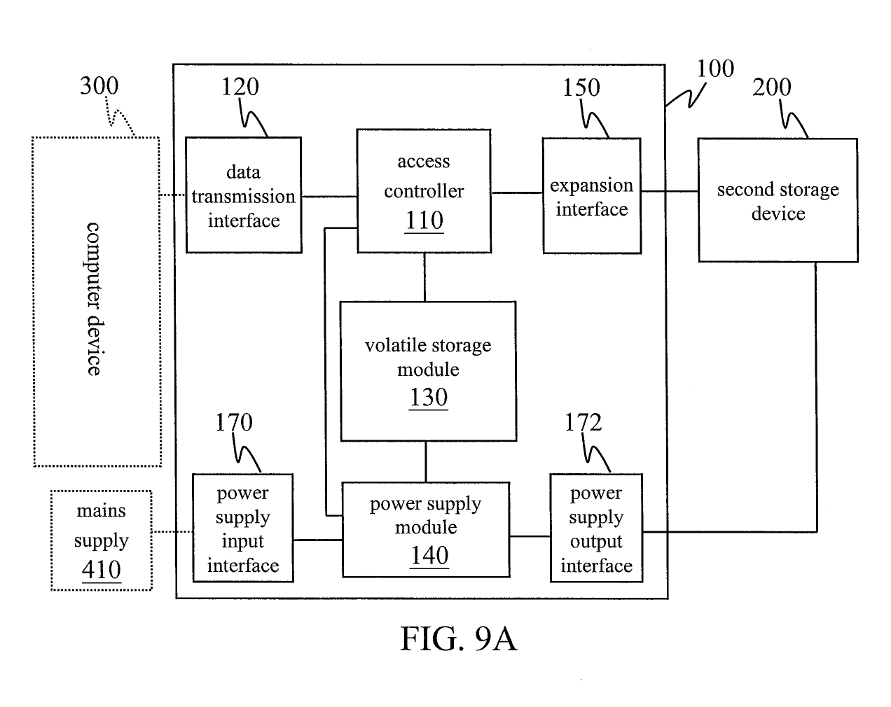

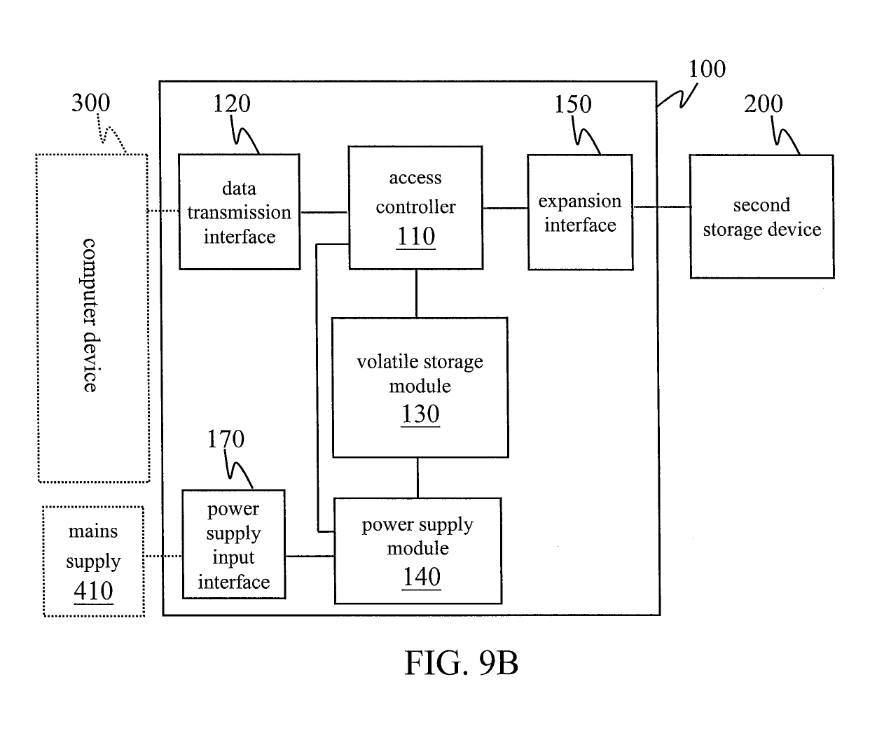

In a fifth embodiment as shown in FIG. 9A, the first storage device 100 can be installed in the same way of installing an external hard disk, and can transmit data by connecting the data transmission interface 120 to the computer device 300, wherein the data transmission interface 120 can be transmission interfaces such as IDE, SATA, USB, or IEEE 1394. The power supply module 140 is powered by a mains supply 410 via the power supply input interface 170. When the non-volatile storage module 210 of the second storage device 200 is a hard disk, the expansion interface 150 for providing connection to the second storage device 200 can be transmission interfaces such as IDE or SATA. At this time, the first storage device 100 supplies the electric power of the power supply module 140 to the second storage device 200 via the power supply output interface 172.

In a sixth embodiment as shown in FIG. 9B, the first storage device 100 is installed in the same way of installing an external hard disk, and can transmit data by connecting the data transmission interface 120 to the computer device 300, wherein the data transmission interface can be transmission interfaces such as IDE, SATA, USB, or IEEE 1394. The power supply module 140 is powered by the mains supply 410 via the power supply input interface 170 and can also be powered via the data transmission interface 120. When the non-volatile storage module 210 of the second storage device 200 is a flash disk, a card reader, or a memory card that can be directly inserted into a USB or IEEE 1394, the expansion interface 150 for providing connection to the second storage device 200 can be transmission interfaces such as USB or IEEE 1394.

Further, when the first storage device 100 has more than two expansion interfaces 150, the expansion interfaces have different specifications namely SATA and USB. The SATA is used to provide connection to the hard disk and supply electric power to the hard disk via the power supply output interface 172, while USB is used to provide connection to the flash disk or the memory card that can be directly inserted into a USB.

The present invention is to provide a volatile storage device and a serial mixed storage system having the same. Therefor, the problems of insufficient storage capacity of the volatile storage device and data loss due to the cut off of the electric power in the prior art can be solved and raise the speed of the computer.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A serial mixed storage system, comprising:
a first storage device, comprising:
an access controller;
a data transmission interface connected to the access controller;
a volatile storage module connected to the access controller;
a power supply module connected to the volatile storage module and the access controller for storing electric power so as to supply electric power to the volatile storage module and the access controller; and
at least one expansion interface connected to the access controller; and
a second storage device connected to the expansion interface;
wherein the access controller is used to control data access of the first storage device and the second storage device.

2. The serial mixed storage system according to claim 1, wherein the second storage device comprises:
at least one non-volatile storage module respectively connected to the expansion interface;
wherein the access controller in the first storage device is used to control data access of the volatile storage module and the non-volatile storage module.

3. The serial mixed storage system according to claim 2, wherein the first storage device further comprises:
at least one power supply output interface respectively connecting the power supply module to the non-volatile storage module, so as to supply the electric power stored in the power supply module to the connected non-volatile storage module.

4. The serial mixed storage system according to claim 3, wherein each power supply output interface is a peripheral component interconnect (PCI) interface or a PCI-Express interface.

5. The serial mixed storage system according to claim 2, wherein the first storage device supplies the required electric power to the non-volatile storage module via each expansion interface.

6. The serial mixed storage system according to claim 1, wherein the first storage device further comprises:
a power supply input interface connected to the power supply module for supplying the electric power from the exterior of the serial mixed storage system to the power supply module.

7. The serial mixed storage system according to claim 6, wherein the electric power from the exterior of the serial mixed storage system is used to maintain the operation of the first storage device.

8. The serial mixed storage system according to claim 7, wherein when the electric power from the exterior of the serial mixed storage system is cut off, the power supply module supplies the stored electric power to the volatile storage module and the access controller, and the data in the volatile storage module is transferred to the second storage device; while when the electric power from the exterior of the serial mixed storage system is supplied again, the data is restored from the second storage device to the volatile storage module.

9. The serial mixed storage system according to claim 8, wherein the second storage device comprises:
at least one non-volatile storage module, respectively connected to the expansion interface;
wherein the access controller in the first storage device is used to control data access of the volatile storage module and the non-volatile storage module.

10. The serial mixed storage system according to claim 9, wherein the first storage device further comprises:
at least one power supply output interface, respectively connecting the power supply module to the non-volatile storage module, so as to supply the electric power stored in the power supply module to the connected non-volatile storage module.

11. The serial mixed storage system according to claim 10, wherein each of the power supply output interfaces is a PCI interface or a PCI-Express interface.

12. The serial mixed storage system according to claim 9, wherein the power supply module of the first storage device supplies the required electric power to the non-volatile storage module via each expansion interface.

13. The serial mixed storage system according to claim 6, wherein the first storage device further comprises:
at least one power supply output interface, respectively connecting the power supply module to the second storage device, for supplying the electric power stored in the power supply module to the second storage device.

14. The serial mixed storage system according to claim 13, wherein each power supply output interface is a PCI interface or a PCI-Express interface.

15. The serial mixed storage system according to claim 6, wherein the power supply module of the first storage device supplies the required electric power to the second storage device via the expansion interface.

16. The serial mixed storage system according to claim 6, wherein the power supply module comprises:
a power supply unit, for storing the electric power to supply the electric power to the volatile storage module and the access controller; and
a power supply monitoring device, connected to the power supply input interface, the power supply unit, the volatile storage module, and the access controller, for monitoring the electric power from the exterior of the serial mixed storage system via the power supply input interface.

17. The serial mixed storage system according to claim 16, wherein when the power supply monitoring device detects that the electric power from the exterior of the serial mixed storage system is cut off, the power supply monitoring device actuates the power supply unit to supply the stored electric power to the volatile storage module and the access controller.

18. The serial mixed storage system according to claim 6, wherein the power supply input interface is a PCI interface or a PCI-Express interface.

19. The serial mixed storage system according to claim 6, wherein the power supply input interface is connected to a computer device.

20. The serial mixed storage system according to claim 6, wherein the power supply input interface is connected to a mains supply.

21. The serial mixed storage system according to claim 1, wherein the first storage device further comprises:
at least one power supply output interface, connected between the power supply module and the second storage device, for supplying the electric power stored in the power supply module to the second storage device.

22. The serial mixed storage system according to claim 21, wherein each power supply output interface is a PCI interface or a PCI-Express interface.

23. The serial mixed storage system according to claim 1, wherein the data transmission interface is an integrated drive electronics (IDE) interface, a serial advanced technology attachment (SATA) interface, a universal serial bus (USB) interface, or an Institute of Electrical and Electronics Engineer 1394 (IEEE 1394) interface.

24. The serial mixed storage system according to claim 1, wherein each expansion interface is an IDE interface, a SATA interface, a USB interface, or an IEEE 1394 interface.

25. A volatile storage device, comprising:
an access controller;
a data transmission interface connected to the access controller;
a volatile storage module connected to the access controller;
a power supply module connected to the volatile storage module for storing electric power to supply the electric power to the volatile storage module and the access controller; and
an expansion interface connected to the volatile storage module for providing connection to a non-volatile storage module;
wherein the access controller is used to control data access of the volatile storage module and the non-volatile storage module.

26. The volatile storage device according to claim 25, further comprising:
a power supply output interface connected between the power supply module and the non-volatile storage module for supplying the electric power to the non-volatile storage module.

27. The volatile storage device according to claim 26, wherein the power supply output interface is a PCI interface or a PCI-Express interface.

28. The volatile storage device according to claim 25, wherein the power supply module supplies the required electric power to the non-volatile storage module via the expansion interface.

29. The volatile storage device according to claim 25, further comprising:
a power supply input interface, connected to the power supply module, for supplying the electric power from the exterior of the volatile storage device to the power supply module.

30. The volatile storage device according to claim 29, wherein the electric power from the exterior of the volatile storage device is used to maintain the operation of the volatile storage device and the access controller.

31. The volatile storage device according to claim 30, when the electric power from the exterior of the volatile storage device is cut off, the power supply module supplies the stored electric power to the volatile storage module and the access controller, and the data in the volatile storage module is transferred to the non-volatile storage module; while when the electric power from the exterior of the volatile storage device is supplied again, the data is restored from the non-volatile storage module to the volatile storage module.

32. The volatile storage device according to claim 29, further comprising:
a power supply output interface connected between the power supply module and the non-volatile storage module for supplying the electric power to the non-volatile storage module.

33. The volatile storage device according to claim 32, wherein the power supply output interface is a PCI interface or a PCI-Express interface.

34. The volatile storage device according to claim 29, wherein the power supply module supplies the required electric power to the non-volatile storage module via the expansion interface.

35. The volatile storage device according to claim 29, wherein the power supply module comprises:
a power supply unit for storing the electric power to supply the electric power to the volatile storage module and the access controller; and
a power supply monitoring device connected to the power supply input interface, the power supply unit, the volatile storage module, and the access controller for monitoring the electric power from the exterior of the volatile storage device.

36. The volatile storage device according to claim 35, wherein when the power supply monitoring device detects that the electric power from the exterior of the volatile storage device is cut off, the power supply monitoring device actuates the power supply unit to supply the stored electric power to the volatile storage module and the access controller.

37. The volatile storage device according to claim 29, wherein the power supply input interface is a PCI interface or a PCI-Express interface.

38. The volatile storage device according to claim 29, wherein the power supply input interface is connected to a computer device.

39. The volatile storage device according to claim 29, wherein the power supply input interface is connected to a mains supply.

40. The volatile storage device according to claim 25, wherein the data transmission interface is an IDE interface, a SATA interface, a USB interface, or an IEEE 1394 interface.

41. The volatile storage device according to claim 25, wherein each expansion interface is an IDE interface, a SATA interface, a USB interface, or an IEEE 1394 interface.
